(19) United States
(12) Patent Application Publication
(10) Pub. No.: US 2008/0294728 A1
(43) Pub. Date: Nov. 27, 2008

(54) Service Discovery for Electronic Messaging Clients

(75) Inventors: Karim Michel Batthish, Seattle, WA (US); Rafiq El Alami, Kirkland, WA (US); Vladimir Grebenik, Redmond, WA (US); Juan Pablo Muraira, Sammamish, WA (US); Harvey Rook, Newcastle, WA (US); Shivakumar Seetharaman, Snoqualmie, WA (US); Paul Tischhauser, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/752,168

(22) Filed: May 22, 2007

(51) Int. Cl. G06F 15/16

(52) U.S. Cl. 709/206

(57) ABSTRACT

An autodiscovery service for clients in an electronic messaging system is disclosed. Client devices in the system request messaging system configuration settings from an autodiscover server. Clients may derive the address of the autodiscover server from user input, such as an email address, or the address may be obtained by other means. The autodiscover server responds to the request with settings for that client. The settings requested may include addresses of electronic mail servers and other servers that provide client services. The autodiscover server may determine the settings for the client based on various criteria, including client location and user mailbox location. Third party servers may participate in the autodiscovery service, and addresses of third party servers may be included in the settings provided to the client devices.

### BACKGROUND

The success of an organization increasingly depends on how quickly, smoothly, and efficiently people within that organization work together. Often, a key to how well people work together is how well that organization manages and distributes information. Networking is an important part of organizational teamwork because it offers the possibility of fast and efficient information exchange. Organizations must also keep track of the information and manage its distribution. Electronic messaging systems provide these capabilities.

Electronic messaging has become critically important to enterprise computing. In fact, many organizations expect their electronic messaging systems to fulfill a central communications backbone, used not only for electronic mail (e-mail or email) messages, but to integrate all types of information. Electronic messaging provides a way for users in organizations to retrieve information from a variety of sources, to exchange information automatically, and to store, filter, and organize the information locally or across a network.

Today, powerful enterprise-wide workgroup applications that manage group scheduling, forms routing, order processing, and project management are built on electronic messaging systems. Hundreds of different messaging systems are offered by different vendors, (including, for example, Microsoft® Exchange, IBM® Lotus Notes®, IBM® Domino®, Novell® Groupwise®, SAP® R/3® Enterprise Software, Oracle® Interoffice™, Oracle® Collaboration Suite (OCS) and others) and a wide range of applications have been built to use them. Part of operating such systems includes configuring clients and servers correctly so that clients can communicate with the system. In particular, client devices need to know which servers to use for various messaging services.

### SUMMARY

In a distributed electronic messaging system, messaging clients are configured using an autodiscover service. An exemplary autodiscover service may comprise, for example, an autodiscover server and one or more autodiscover clients. An exemplary autodiscover server comprises configuration settings which may include, for example, the addresses or locations of servers that provide messaging services to clients. An autodiscover server may additionally comprise data for configuration other than for electronic messaging including, for example, network and connectivity parameters, policy, user profiles, etc.

In an exemplary system, a client gathers information, which may be a user's email address and/or the client device's IP address and generates a list of possible autodiscovery servers that might be adapted to service the particular client. The client transmits a request to an autodiscover server by issuing an autodiscover request, which may include information to facilitate the autodiscover process. The information may comprise, for example, the client's IP address or a listing of services required by the client. The autodiscover server responds to the request with an indication of servers that can provide the services needed by the client. The autodiscover server may identify the servers based on various criteria, including, for example, the location of the user's mailbox and the location of the client in relation to the service-providing servers. The infrastructure supporting the autodiscover service is extensible, allowing the use of third party client service providers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects discussed. In the drawings:

FIG. 1 is a diagram of an example electronic messaging system environment;

FIG. 2 is a flow diagram of a method of providing autodiscover service;

FIG. 3 is a block diagram representing an exemplary non-limiting computing device in which the present disclosure or parts thereof may be implemented; and

FIG. 4 is a block diagram representing an exemplary network environment having a variety of computing devices in which the present disclosure or parts thereof may be implemented.

### DETAILED DESCRIPTION

### Overview

A typical electronic messaging system includes servers that provide messaging related services, and clients that communicate with the servers. Clients communicate with each other through the messaging system servers. In order for clients to be able to communicate with each other, the clients need to be configured with information about the messaging system servers. Typically, configuration information is put in place manually, which requires that a person access and configure the client. This process can consume significant time and resources. Moreover, the client may be a mobile device or other type of device that may be difficult to configure manually simply due to physical limitations.

The person configuring the client may not have the most recent information regarding the messaging system which may lead to less than optimal configurations being made. For example, the person performing a manual configuration may not have the most up to date information regarding which servers provide which messaging services, which servers are the closest to the client, which servers are overburdened, or which servers are underserved by the network. Therefore, the person configuring the client may not configure it with the servers that provide optimum service to the client. If the client is configured to use a server that is far away geographically when a closer one is available, that configuration may waste network and hardware resources, a situation that could easily be avoided with current information.

Applicants disclose systems and methods for automating the distribution of configuration information to clients. In one exemplary and non-limiting aspect of the present disclosure, an autodiscover server is included in an electronic messaging system to provide configuration information to newly connected clients. The autodiscover server uses information received in a request from a newly connected client to determine the best servers to provide messaging-related services to the client based on various criteria. The autodiscover server may gather information about client services servers and their locations within the system before or after receiving a request from a new client, and determine best service-providing servers before or after receiving the request. The autodiscover server then sends a response to the new client providing configuration settings for the client.

In another exemplary and non-limiting aspect of the present disclosure, the client's IP address is provided to the autodiscover server. The autodiscover server may use the IP address to determine location information about the client, and returns configuration information containing the closest best service-providing servers to the client. By providing services from devices that are closest to the client, network efficiency is improved and response time for client tasks are reduced.

In yet another exemplary and non-limiting aspect of the present disclosure, extensibility is provided for in the electronic messaging system. Third party providers of messaging services are permitted to register with the messaging system. When requests from clients are received on the autodiscover server, the third party service-providing servers may be included in the response to the client if those servers are among the best available service-providing servers for that particular client.

### Autodiscovery Service for Electronic Messaging Clients

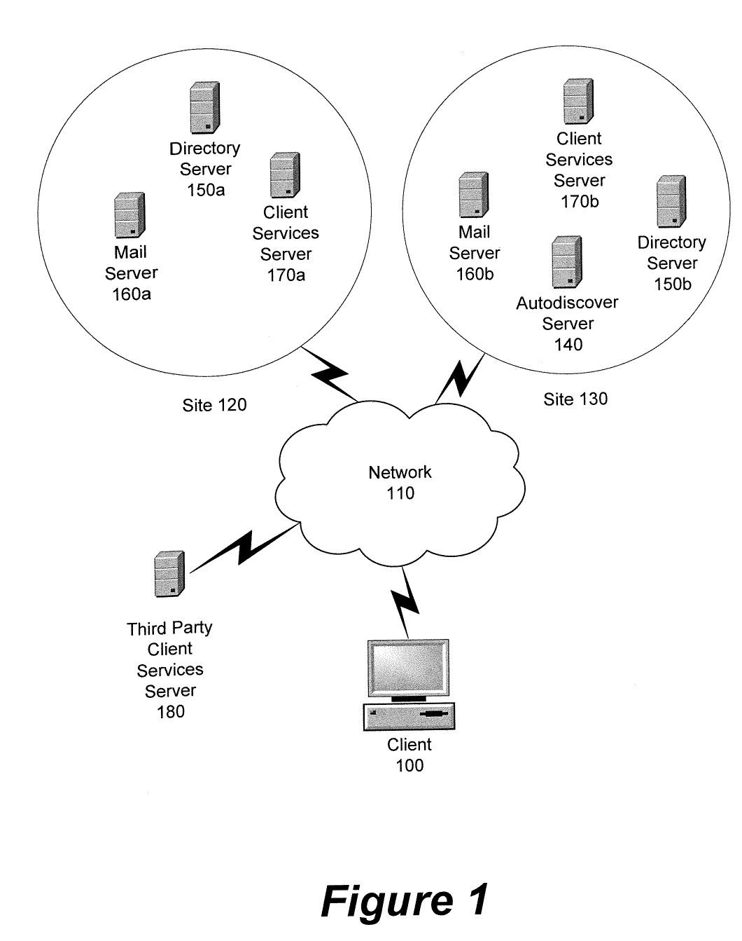

FIG. 1 illustrates an exemplary, non-limiting electronic messaging system environment. For simplicity of explanation, there are two sites illustrated in the figure, Site 120 and Site 130. However, it is contemplated that the present disclosure will be useful in systems with any number of sites. A client 100 is shown, which may be a personal computer, laptop, server, mobile device, or any other computing device capable of acting as a client in an electronic messaging system. The devices within Site 120 and Site 130, as well as client 100, are connected to network 110 which allows communication between them. A single network 110 is shown for simplicity of explanation, although those skilled in the art will appreciate that additional networks may be employed. The present disclosure may be useful in systems utilizing any type of network or multiple networks providing any communications means between computing devices, including, but not limited to, local area networks (LANs), wide area networks (WANs), wireless and radio networks, and the Internet.

Several servers may be comprised in each of sites 120 and 130. Autodiscover server 140 receives requests from clients for configuration information and replies to those requests. Mail servers 160a and 160b provide electronic mail services for clients. Client services servers 170a and 170b provide other client services, and are merely representative of various servers that may be part of a messaging system. These services may include, but are not limited to, address book services, availability services, instant messaging services, and calendar services. Directory servers 150a and 150b provide directory services, including storing and organizing information about network resources and devices attached to the network such as mail servers and other client services servers like servers 160a, 160b, 170a, and 170b. Directory servers 150a and 150b also contain network topology information. Third party client services server 180 may be owned or operated by a third party. Server 180 is shown located outside of Sites 120 and 130, but may be located on-site with other equipment owned or managed by the organization operating the messaging system.

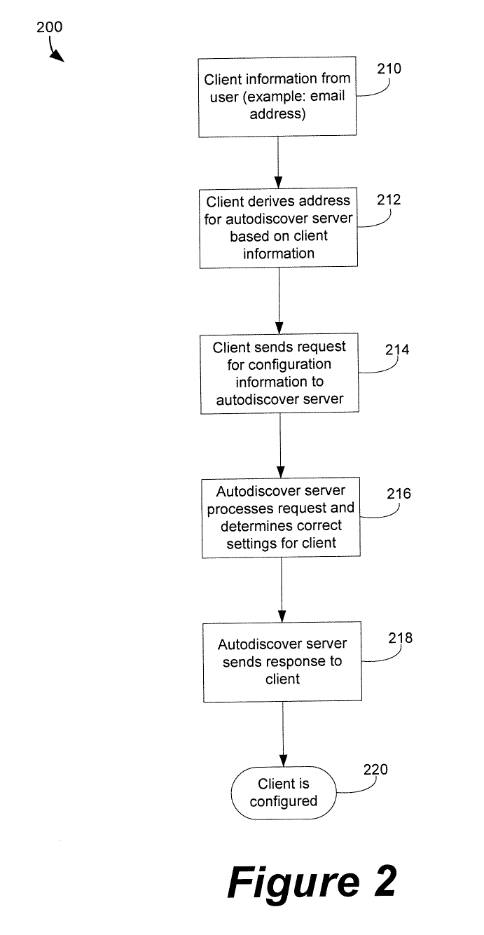

FIG. 2 illustrates an exemplary, non-limiting exemplary embodiment of an autodiscover process 200. Those skilled in the art appreciate that client 100, autodiscover server 140, and the other servers described above may be programmed with machine-readable instructions to perform the various steps of the described process.

At step 210, client 100, after being connected to network 110, gathers information from the user, preferably through a software interface such as a dialog box. Client 100 may gather, for example, a user's email address. At step 212, client 100 may use the email address to derive location information for the autodiscover server 140. For example, the user may provide the email address “johndoe@exchange.microsoft.com.” Client 100 uses the fully qualified domain name (FQDN) portion of the email address (in this example, the FQDN is “exchange.microsoft.com”) to develop an address for a potential autodiscover server. The address may be in the form of a uniform resource locator (URL), such as https://exchange.microsoft.com/autodiscover/autodiscover.xml. In an exemplary embodiment, an algorithm within the client 100 software determines alternative autodiscover server addresses if there is no autodiscover server at the initially derived address, or the server at that address does not successfully provide the configuration settings needed by client 100. These alternatives may or may not be based on the email address, depending on the embodiment. In another embodiment, the client 100 may be configured manually with autodiscover server addresses to use either as initial autodiscover servers, or as fall-back addresses should the address derived from user-provided information prove unusable. Other embodiments of the autodiscover server address generation process are contemplated as being within the scope of this disclosure, including, but not limited to, having the user enter the server address, having the client-side software preconfigured with addresses, and using addresses other than URL-type address, such as Internet Protocol (IP) addresses or other network protocol addresses.

At step 214, once client 100 determines an autodiscover server 140 address, client 100 sends a request for configuration information to autodiscover server 140. The request may be in any form that enables the successful completion of the autodiscover process. In an exemplary embodiment, the request is sent using an HTTP post command, with an XML request within the HTTP post data requesting the configuration information. Other forms of sending requests to autodiscover server 140 are contemplated as within the present disclosure. The request may contain the user's email address, client 100's IP address, protocols supported by client 100, services required by the client 100, and/or any other information that may be useful in helping autodiscover server 140 determine the correct configuration settings to send to client 100. It may also contain information useful for ensuring compatibility between devices, such as software version, operating system, hardware types, etc.

At step 216, autodiscover server 140 determines the correct settings for client 100. Autodiscover server 140 may have previously generated configuration information for clients before the requests are received, may have been preconfigured with client information, and/or may generate configuration information in response to specific requests. In order to make decisions about which configuration settings are best for a particular client, autodiscover server 140 may need to know about the client services servers, other client resources, and the locations of such services and resources in the network relative to the client. Autodiscover server 140 gathers information about the network and the resources from directory server 150b. This information may be gathered using application programming interfaces (APIs) to request data from the directory server, but other methods of extracting the needed data from a directory server are contemplated as within the scope of the present disclosure. The information gathering by autodiscover server 140 may take place before requests from clients are handled, to improve efficiency and response time, or on a per-request basis, with autodiscover server 140 only gathering information related to client 100 from directory server 150b. Other ways of autodiscover server 140 gathering network topology information beyond using the directory server are contemplated as being within the scope of the present disclosure.

Autodiscover server 140 may use various criteria to determine the best configurations to send to client 100. In one embodiment, autodiscover server 140 determines the location of the server on which client 100's user's mailbox resides, and then sends client 100 configurations that will direct requests for all other client services to servers that are closest to the client's mailbox. For example, if the client 100's user's mailbox is located on mail server 160a in Site 120, then autodiscover server 140 will direct client 100 to use client services server 170a for client services. On the other hand, if client 100's user's mailbox is located on mail server 160b in Site 130, then autodiscover server 140 will direct client 100 to use client services server 170b for client services.

In another embodiment, autodiscover server 140 determines the geographic location of client 100 and sends client 100 configurations that will direct requests for all client services to servers that are closest to the site where client 100 is located. For example, if client 100 is in, or connected directly to, Site 120, then autodiscover server 140 will direct client 100 to use client services server 170a for client services, and directory server 150a for directory services. Autodiscover server 140 may configure client 100 in this way even if client 100's mail box is located on mail server 160b in Site 130. This reduces network resource utilization by ensuring that clients use the closest servers possible for services. On the other hand, autodiscover server 140 may be aware of problems or overutilization of certain servers, and could stop directing clients to those servers, regardless of how close the clients are to the overutilized servers. In this way, the autodiscover process can help maintain optimum resource availability. Other embodiments are contemplated that encompass any criteria that may be useful in determining client configurations.

In yet another exemplary embodiment, in which client 100 includes its own IP address within its request for configuration information, autodiscover server 140 uses client 100's IP address to make a determination about the best configuration settings to send to client 100. Autodiscover server 140 uses the IP address to determine the site in which client 100 is located. This may be done by determining the subnetwork to which client 100 is connected. It is very likely that any client services servers, such as 170a or 170b, that are on the same subnetwork are geographically close to client 100, so autodiscover server 140 may use this method to determine the best client services server addresses to include in the configuration settings. Alternatively, autodiscover server 140 may use client 100's IP address to look up the client site location in a table or database. Autodiscover server 140 may also use directory servers 150a or 150b to determine the site location based on client 100's IP address. Once the site is identified, autodiscover server 140 selects configuration settings for client 100 that would direct client 100 to use client services servers located in the same site as client 100.

If there are services needed by client 100 that are not served by servers in the client's site, then autodiscovery server 140 may look at the network topology to determine which servers are closest to client 100. To accomplish this, autodiscover server 140 may use information collected from a directory server (350a or 350b). In another embodiment, autodiscover server 140 may look at the network topology and the network path “cost” for connections between client 100 and the available client services servers, selecting the servers with the lowest cost path to client 100 for the configuration settings. The cost for connections can be based on many different criteria, such as hop count, bandwidth, network metrics, preconfigured preferences, etc. Methods of providing cost values for network paths and algorithms for determining lowest cost paths are well known to those skilled in the art.

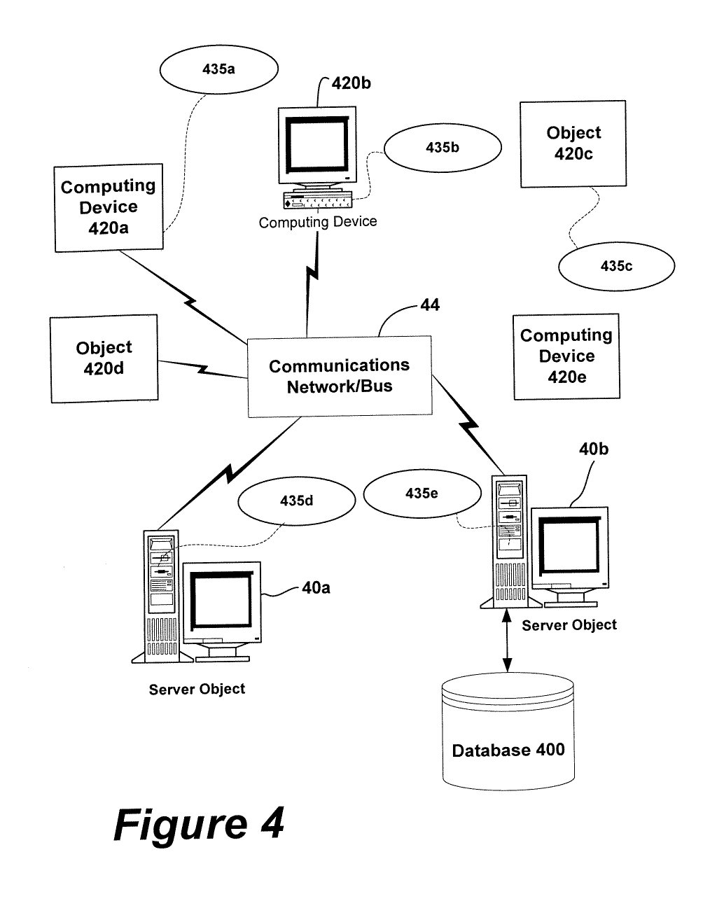

After autodiscover server 140 determines the best configuration settings for requesting client 100, it sends the settings back to client 100 at step 218 of FIG. 4. In an exemplary embodiment, the response is sent in the form of an XML file containing the information required to configure the client with the correct server addresses for the services it requires. Other forms, format, and types of responses are contemplated as being within the scope of the present disclosure.

In an exemplary embodiment, an extensibility mechanism is provided to allow third party client service providers to participate in the autodiscovery service. The third party service provider will register with a directory server, such as directory servers 150a and 150b, as a client service provider. The necessary information will be stored in the directory server, and provided to autodiscover server 140 when autodiscover server 140 requests client services information. If autodiscover server 140 determines that configuration settings directing client 100 to third party server 180 are appropriate, autodiscovery server 140 will provide those settings to client 100, along with any other required settings. It is contemplated that autodiscover server 140 may learn about third party client service providing servers such as server 180 through other means than a directory server, and that registration by a third party service provider with a directory may not be necessary. Various other embodiments allowing the integration of third party client service providers are contemplated as within the scope of the present disclosure.

### Exemplary Computing Environment

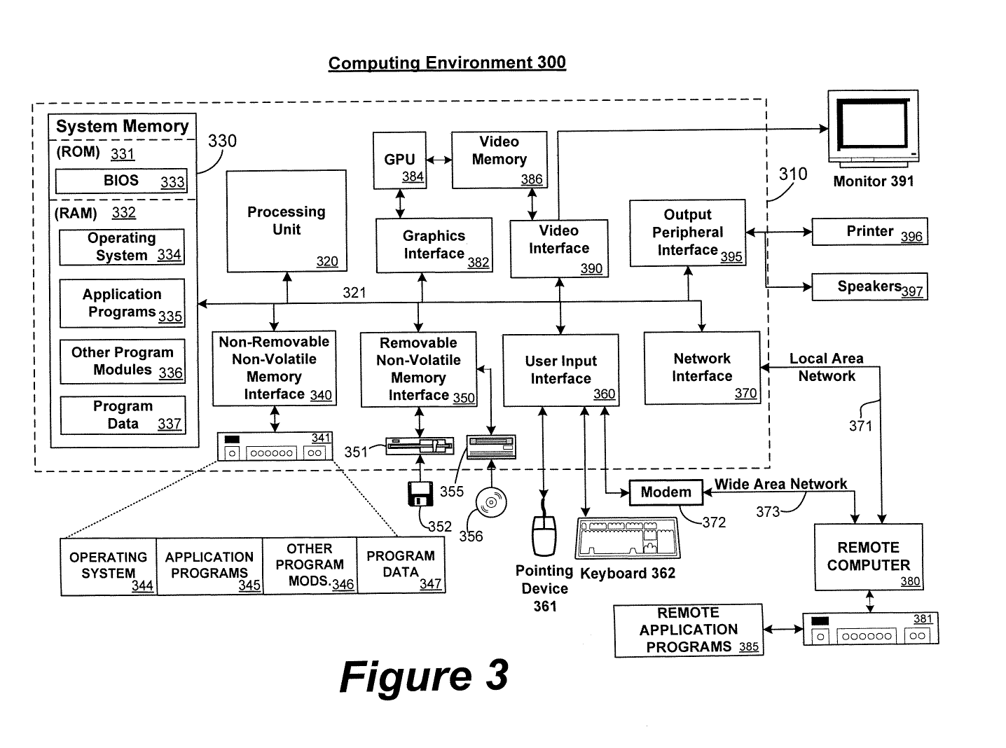

FIG. 3 and the following discussion are intended to provide a brief general description of a suitable computing environment in which the present disclosure or parts thereof may be implemented. It should be understood, however, that handheld, portable and other computing devices and computing objects of all kinds are contemplated for use in connection with the present disclosure, as described above. Thus, while a general purpose computer is described below, this is but one example, and the present disclosure may be implemented with other computing devices, such as a thin client having network/bus interoperability and interaction. The present disclosure may be implemented in an environment of networked hosted services in which very little or minimal client resources are implicated, e.g., a networked environment in which the client device serves merely as an interface to the network/bus, such as an object placed in an appliance, or other computing devices and objects as well. In essence, anywhere that an electronic messaging system may be employed is a desirable, or suitable, environment for the autodiscovery service of the disclosure.

Although not required, the present disclosure can be implemented via an operating system, for use by a developer of services for a device or object, and/or included within application software that operates in connection with the electronic messaging system. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the present disclosure may be practiced with other computer system configurations. Other well known computing systems, environments, and/or configurations that may be suitable for use with the present subject matter include, but are not limited to, personal computers (PCs), automated teller machines, server computers, hand-held or laptop devices, multi-processor systems, microprocessor-based systems, programmable consumer electronics, network PCs, appliances, environmental control elements, minicomputers, mainframe computers and the like. The disclosure may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 3 thus illustrates an example of a suitable computing system environment 300 in which the present subject matter or parts thereof may be implemented, although as made clear above, computing system environment 300 is only one example of a suitable computing environment and is not intended to suggest any limitation as to the scope of use or functionality of the disclosure. Devices such as client 100 and autodiscover server 140 may be implemented using a system such as computing system environment 300, but those skilled in the art will recognize that there are other appropriate systems in which to implement the present disclosure. Computing environment 300 should not be interpreted as having any dependency or requirement relating to any one or combination of components illustrated in the exemplary operating environment 300.

With reference to FIG. 3, an exemplary system for implementing the disclosure includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

System memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

Computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 341 is typically connected to the system bus 321 through an non-removable memory interface such as interface 340, and magnetic disk drive 351 and optical disk drive 355 are typically connected to system bus 321 by a removable memory interface, such as interface 350.

The drives and their associated computer storage media discussed above and illustrated in FIG. 3 provide storage of computer readable instructions, data structures, program modules and other data for computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into computer 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to processing unit 320 through a user input interface 360 that is coupled to system bus 321, but may be connected by other interface and bus structures, such as a parallel port, game port or a universal serial bus (USB). A graphics interface 382 may also be connected to system bus 321. One or more graphics processing units (GPUs) 384 may communicate with graphics interface 382. In this regard, GPUs 384 generally include on-chip memory storage, such as register storage and GPUs 384 communicate with a video memory 386. GPUs 384, however, are but one example of a coprocessor and thus a variety of coprocessing devices may be included in computer 310. A monitor 391 or other type of display device is also connected to system bus 321 via an interface, such as a video interface 390, which may in turn communicate with video memory 386. In addition to monitor 391, computers may also include other peripheral output devices such as speakers 397 and printer 396, which may be connected through an output peripheral interface 395.

Computer 310 may operate in a networked or distributed environment using logical connections to one or more remote computers, such as a remote computer 380. Remote computer 380 may be a personal computer, a server, a router, a network PC, a peer device or other common network node, and typically includes many or all of the elements described above relative to computer 310, although only a memory storage device 381 has been illustrated in FIG. 3. The logical connections depicted in FIG. 3 include a local area network (LAN) 371 and a wide area network (WAN) 373, but may also include other networks/buses. Such networking environments are commonplace in homes, offices, enterprise-wide computer networks, intranets and the Internet.

When used in a LAN networking environment, computer 310 is connected to LAN 371 through a network interface or adapter 370. When used in a WAN networking environment, computer 310 typically includes a modem 372 or other means for establishing communications over WAN 373, such as the Internet. Modem 372, which may be internal or external, may be connected to system bus 321 via user input interface 360, or other appropriate mechanism. In a networked environment, program modules depicted relative to computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

### Exemplary Networked and Distributed Environments

One of ordinary skill in the art can appreciate that a computer, such as computer 300, client 100, autodiscover server 140, or other client or server device can be deployed as part of a computer network, or in a distributed computing environment. In this regard, the present disclosure pertains to any computer system as described above, having any number of memory or storage units, and any number of applications and processes occurring across any number of storage units or volumes, which may be used in connection with an electronic messaging system. The present disclosure may apply to an environment with server computers and client computers deployed in a network environment or distributed computing environment, having remote or local storage. The present disclosure may also be applied to standalone computing devices, having programming language functionality, interpretation and execution capabilities for generating, receiving and transmitting information in connection with remote or local electronic messaging services.

Distributed computing facilitates sharing of computer resources and services by direct exchange between computing devices and systems, such as the exchange described above between client 100 and autodiscover server 140. These resources and services include the exchange of information, cache storage, and disk storage for files. Distributed computing takes advantage of network connectivity, allowing clients to leverage their collective power to benefit the entire enterprise. In this regard, a variety of devices may have applications, objects or resources that may implicate an electronic messaging system that may utilize the techniques of the present subject matter.

FIG. 4 provides a schematic diagram of an exemplary networked or distributed computing environment. The distributed computing environment comprises server computing objects 40a, 40b, etc. and computing objects or devices 420a, 420b, 420c, etc. These objects may comprise programs, methods, data stores, programmable logic, etc. The objects may comprise portions of the same or different devices such as personal digital assistants (PDAs), televisions, Moving Picture Experts Group (MPEG-1) Audio Layer-3 (MP3) players, televisions, personal computers, etc. Each object can communicate with another object by way of the communications network 44. This network may itself comprise other computing objects and computing devices that provide services to the system of FIG. 4. In accordance with an aspect of the present disclosure, each object 40a, 40b, etc. or 420a, 420b, 420c, etc. may contain an application that might request electronic messaging services.

In a distributed computing architecture, computers, which may have traditionally been used solely as clients, communicate directly among themselves and can act as both clients and servers, assuming whatever role is most efficient for the network. This reduces the load on servers and allows all of the clients to access resources available on other clients, thereby increasing the capability and efficiency of the entire network. Electronic messaging services in accordance with the present disclosure may thus be distributed among servers, and possibly clients, acting in a way that is efficient for the entire network.

Distributed computing can help businesses deliver services and capabilities more efficiently across diverse geographic boundaries. Moreover, distributed computing can move data closer to the point where data is consumed acting as a network caching mechanism. Distributed computing also allows computing networks to dynamically work together using intelligent agents. Agents reside on peer computers and communicate various kinds of information back and forth. Agents may also initiate tasks on behalf of other peer systems. For instance, intelligent agents can be used to prioritize tasks on a network, change traffic flow, search for files locally or determine anomalous behavior such as a virus and stop it before it affects the network. All sorts of other services may be contemplated as well. Since electronic messages and messaging data may in practice be physically located in one or more locations, the ability to distribute electronic messaging services is of great utility in such a system.

It can also be appreciated that an object, such as 420c, may be hosted on another computing device 40a, 40b, etc. or 420a, 420b, etc. Thus, although the physical environment depicted may show the connected devices as computers, such illustration is merely exemplary and the physical environment may alternatively be depicted or described comprising various digital devices such as PDAs, televisions, mobile telephones, etc., software objects such as interfaces, COM objects and the like.

There are a variety of systems, components, and network configurations that support distributed computing environments. For example, computing systems may be connected together by wireline or wireless systems, by local networks or widely distributed networks. Currently, many of the networks are coupled to the Internet, which provides the infrastructure for widely distributed computing and encompasses many different networks.

The Internet commonly refers to the collection of networks and gateways that utilize the Transport Control Protocol/Interface Program (TCP/IP) suite of protocols, which are well-known in the art of computer networking. The Internet can be described as a system of geographically distributed remote computer networks interconnected by computers executing networking protocols that allow users to interact and share information over the networks. Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 4, computers 420a, 420b, etc. can be thought of as clients and computer 40a, 40b, etc. can be thought of as the server where server 40a, 40b, etc. maintains the data that is then replicated in the client computers 420a, 420b, etc.

A server is typically a remote computer system accessible over a local network such as a LAN or a remote network such as the Internet. The client process may be active in a first computer system, and the server process may be active in a second computer system, communicating with one another over a communications medium, thus providing distributed functionality and allowing multiple clients to take advantage of the information-gathering capabilities of the server.

Client and server communicate with one another utilizing the functionality provided by a protocol layer. For example, Hypertext-Transfer Protocol (HTTP) is a common protocol that is used in conjunction with the World Wide Web (WWW). Typically, a computer network address such as a Universal Resource Locator (URL) or an Internet Protocol (IP) address is used to identify the server or client computers to each other. The network address can be referred to as a URL address. For example, communication can be provided over a communications medium. In particular, the client and server may be coupled to one another via TCP/IP connections for high-capacity communication.

Thus, FIG. 4 illustrates an exemplary networked or distributed environment, with a server in communication with client computers via a network/bus, in which the present disclosure may be employed. In more detail, a number of servers 40a, 40b, etc., are interconnected via a communications network/bus 44, which may be a LAN, WAN, intranet, the Internet, etc., with a number of client or remote computing devices 420a, 420b, 420c, 420d, 420e, etc., such as a portable computer, handheld computer, thin client, networked appliance, mobile telephone, or other device, in accordance with the present disclosure. It is thus contemplated that the present disclosure may apply to any computing device in connection with which it is desirable to communicate with an electronic messaging system.

In a network environment in which the communications network/bus 44 is the Internet, for example, the servers 40a, 40b, etc. can be Web servers with which the clients 420a, 420b, 420c, 420d, 420e, etc. communicate via any of a number of known protocols such as HTTP. Servers 40a, 40b, etc. may also serve as clients 420a, 420b, 420c, 420d, 420e, etc., as may be characteristic of a distributed computing environment. Communications may be wired or wireless, where appropriate. Client devices 420a, 420b, 420c, 420d, 420e, etc. may or may not communicate via communications network/bus 44, and may have independent communications associated therewith. Each client computer 420a, 420b, 420c, 420d, 420e, etc. and server computer 40a, 40b, etc. may be equipped with various application program modules or objects 435 and with connections or access to various types of storage elements or objects, across which files may be stored or to which portion(s) of files may be downloaded or migrated. Any computer 40a, 40b, 420a, 420b, etc. may be responsible for the maintenance and updating of a database 400 or other storage element in accordance with the present subject matter, such as a database or memory 400 for storing electronic messages or data processed according to the present disclosure. Thus, the present disclosure can be utilized in a computer network environment having client computers 420a, 420b, etc. that can access and interact with a computer network/bus 44 and server computers 40a, 40b, etc. that may interact with client computers 420a, 420b, etc. and other like devices, and databases 400.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for providing electronic messaging configuration settings to a client device in an electronic messaging system, the method comprising:
transmitting a request for configuration settings from a client device to an autodiscover server;
determining, on the autodiscover server, at least one configuration setting for the client;
transmitting the at least one configuration setting from the autodiscover server to the client device; and
configuring the client device with the at least one configuration setting.

2. The method of claim 1, further comprising:
collecting user input on the client device; and
determining an address for the autodiscover server based on the user input.

3. The method of claim 2, wherein collecting user input on the client device comprises collecting at least an email address.

4. The method of claim 3, wherein determining an address for the autodiscover server based on the user input comprises determining the address of the autodiscover server based on a fully qualified domain name derived from the email address.

5. The method of claim 1, wherein transmitting a request for configuration settings comprises transmitting a request for configuration settings comprising an IP address of the client device.

6. The method of claim 1, wherein determining at least one configuration setting for the client comprises determining at least one configuration setting for the client based on the location of the client device.

7. The method of claim 1, wherein determining at least one configuration setting for the client comprises determining at least one configuration setting for the client based on the location of an electronic mail server hosting an electronic mailbox associated with a user of the client device.

8. The method of claim 1, wherein determining at least one configuration setting for the client comprises determining at least one address of a server providing client services.

9. The method of claim 8, wherein the at least one address of a server providing client services is a uniform resource locator (URL) associated with the server.

10. The method of claim 8, wherein the at least one address of a server providing client services is an IP address associated with the server.

11. The method of claim 8, wherein the at least one address of a server providing client services comprises at least one electronic mail server address.

12. One or more computer-readable storage media comprising computer-readable instructions for performing a method of selecting a server to provide client services for a client device, comprising:
computer-readable instructions for determining an IP address of a client device located in a first site;
computer-readable instructions for determining a location of the first site based on the IP address; and
computer-readable instructions for identifying a server from among a plurality of servers located at the first site, and transmitting an address of the identified server to the client device.

13. The one or more computer-readable storage media of claim 12, further comprising computer-readable instructions for identifying a lack of a server from the plurality of servers located at the first site, and, identifying a server from among the plurality of servers located in a site closest to the first site.

14. The one or more computer-readable storage media of claim 13, wherein the computer-readable instructions for identifying a server from among the plurality of servers located in a site closest to the first site comprises identifying a site based on the network cost between the first site and the server site.

15. The one or more computer-readable storage media of claim 12, wherein the computer-readable instructions for identifying a server from the plurality of servers located at the first site comprises identifying a server associated with the same subnetwork as the client.

16. A system for creating extensibility in an electronic messaging system, comprising:
a processor operable to execute computer-readable program instructions; and
computer-readable program instructions for:
registering an address of a third party server with a directory server in an electronic messaging system, said third party server providing at least one service for client devices in the electronic messaging system; and
transmitting the third party server's address from the directory server to a client device.

17. The system of claim 16, wherein transmitting the third party server's address from the directory server comprises transmitting the third party server's address via an autodiscovery service.

18. The system of claim 16, wherein transmitting the third party server's address comprises transmitting the address of an electronic mail server.

19. The system of claim 16, wherein transmitting the third party server's address comprises transmitting a uniform resource locator (URL) associated with the third party server.

20. The system of claim 16, wherein transmitting the third party server's address comprises transmitting an IP address associated with the third party server.
